(19) United States
(12) Patent Application Publication
(10) Pub. No.: US 2005/0219966 A1
(43) Pub. Date: Oct. 6, 2005

(54) Spindle unit and a spinstand and a method of disk exchanging in the spinstand

(75) Inventors: Eiji Ishimoto, Hyogo (JP); Takahisa Mihara, Hyogo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/095,701

(22) Filed: Mar. 31, 2005

(30) Foreign Application Priority Data
Apr. 2, 2004 (JP) 2004-110582

(51) Int. Cl. G11B 7/085

(52) U.S. Cl. 369/30.27

(57) ABSTRACT

A spindle unit installed in a spinstand for testing at least one component selected from the group consisting of: a head and a disk, wherein the spindle unit comprises a disk rotation device for holding and rotating a disk and a spindle base loaded with the disk rotation device. The spindle unit has a spindle base that is fixed to the spinstand so as to enable installation and removal by the operator of the spinstand. The disk is detachably attached to the disk rotation device.

### FIELD OF THE INVENTION

The present invention relates to a spinstand for testing at least any one of a head and a disk.

### DISCUSSION OF THE BACKGROUND ART

A spinstand is a device for testing at least any one of a head and a disk. A conventional spinstand has several forms. A typical spinstand comprises a granite or metal base, a head positioning device fixed on the base, and a disk rotating device. The head positioning device holds the head and positions the head relative to the disk. The disk rotation device holds and rotates the disk. A spinstand having this structure is disclosed, for example, in Published Japanese translation of a PCT application 2002-518,777 as FIG. 1.

Another typical spinstand comprises a metal base, a head positioning device fixed on the base, and a disk rotation device rotatably connected to a frame provided on the base. The disk rotation device is firmly fixed to the base during measurement. When a disk is exchanged, the disk rotation device is released from the fixing to the base and is rotated around the rotation support axis on the base so that the operator (referred to as the tester or the test operator) of the spinstand can easily access the disk. A spinstand having this kind of structure is disclosed, for example, in Unexamined Japanese Patent Publication No. 2001-344883 as 1.

The conventional spinstands described above had problems during the disk exchange. First, the disk was exchanged on the disk rotation device fixed to the spinstand. In this case, the disk exchange time directly becomes the down time of the spinstand and is a factor of lowering the operating rate of the spinstand. In addition, the disk is easily damaged and the handling thereof requires meticulous care. When the disk is directly handled by the test operator, accidents easily occur while handling the disk. In case a trained operator for the disk exchange handles a disk, it incurs a waste of man-hour such as standby time of the trained operator for disk exchange. These accidents and wait times are factors inhibiting improvements in the test quality and the manufacturability. Furthermore, the disk rotation device used an expensive, large, and heavy air spindle motor in order to address various test specification changes such as changes in the disk diameter, changes in the disk rotation speed, and changes in the disk rotation direction. Therefore, decreasing the size, lowering the power consumption, and reducing the cost of the spinstand were difficult.

Furthermore, in the latter spinstand, the disk exchange operation becomes a burden on the test operator who is responsible for disk exchange operation with lifting the spindle unit including disk rotation device once vertically then rotating the unit. An object of the present invention is to solve the above problems. The novel spinstand according to the present invention shortens the disk exchange time compared to conventional spinstands. The present invention also provides a spinstand that suppresses degradation in the test quality caused by the operator's mistakes. The present invention also provides a spinstand able to quickly handle tests having various specifications. Finally, the present invention provides a method of disk exchanging in the spinstand provided by the present invention.

### SUMMARY OF THE INVENTION

A spindle unit for exchanging the disk or the disk rotator for holding and rotating the disk in a spinstand for testing at least one of a head and a disk, comprised of a disk rotator and a spindle base for installing the disk rotator, and the spindle base is fixed in the spinstand (so as to enable installation and removal of the spindle unit) or, (detachably) by the operator of the spinstand.

The disk rotator has a mechanism for holding the disk detachably, and the disk can be exchanged in the disk rotator outside of the spinstand. The disk rotator is fixed detachably to the spindle base, and can be exchanged in the spindle base outside of the spinstand. The disk rotator is selected according to the test specifications from a variety of disk rotators. The disk rotator comprises a fluid dynamic bearing motor for rotating the disk. The spindle unit comprises means for controlling the disk rotation.

Additionally a connector is provided for electrically connecting to the spinstand or another device.

A spinstand comprised of a spindle unit as discussed above, a base for fixing the spindle unit, and a head positioning means for holding the head and positioning the head relative to the disk held by the spindle unit.

A spinstand system comprised of a spinstand for testing at least any one of a head and a disk, and a set of disk rotators that can be installed detachably in the spinstand, wherein the spinstand fixes at least one of a set of the same type of the disk rotators and has a structure where the disk rotator can be exchanged while the disk is held by the disk rotator. A set of the same type of the disk rotators is selected from multiple types of disk rotators according to the test specification.

A spinstand system comprised of a spinstand for testing at least any one of a head and a disk, and a set of disk rotators which can be installed detachably in the spinstand, wherein the spinstand fixes detachably the disk rotator selected in accordance with the test specification from multiple types of disk rotators, and the disk rotator to can be exchanged while the disk is held by the disk rotator.

A method of disk exchanging in the spinstand with a disk rotator fixed detachably, wherein a step for preparing a second disk rotator separate from the first disk rotator holding the first disk and being fixed in the spinstand, a step for attaching a second disk in the second disk rotator before installation in the spinstand, a step for removing the first disk rotator with the first disk from the spinstand, and a step for fixing the second disk rotator with the second disk in the spinstand, are included.

A method of disk exchanging in the spinstand with a spindle unit holding a disk rotator and being fixed detachably, wherein a step for preparing a second spindle unit separate from the first spindle unit with the first disk and fixed in the spinstand, a step for attaching a second disk in the second spindle unit before installing in the spinstand, a step for removing the first spindle unit from the spinstand with the first disk loaded, and a step for fixing the second spindle unit with the second disk in the spinstand, are included.

### BRIEF DESCRIPTION OF THE DRAWINGS

FIG. 1 is a perspective view showing the spinstand 10 of the present invention.

FIG. 2 is a perspective view showing the spinstand 10 of the present invention.

FIG. 3 is a perspective view showing the spindle unit 300 of the present invention.

FIG. 4 is an exploded assembly diagram showing the spindle unit 300 of the present invention.

### DETAILED DESCRIPTION OF THE PREFERRED EMBODIMENT

According to the present invention, the disk is exchanged in the spinstand by exchanging the disk rotator holding the disk or the spindle unit holding the disk, and the time needed for the disk exchange is substantially shorter than in the past. In addition, the test operator can exchange the disk in the spinstand without directly touching the disk and can suppress the occurrence of accidents accompanying the exchange. Furthermore, since an operator trained in disk exchange can exchange the disk at one centralized location, the operator trained in disk exchange has better inspection efficiency and operating efficiency in disk exchange compared to going to the installation location of the spinstand and making the exchange as in the past.

According to the present invention, the head or disk is tested by providing multiple types of spindle unit or disk rotator that can be installed and removed and combining spindle units or disk rotators selected in accordance with the inspection specification in the base of the spinstand. Consequently, each spindle unit or each disk rotator does not have to cover the entire wide range of specifications and an ultra-compact spindle motor employing, for example, a fluid dynamic bearing can be used. Therefore, a spinstand equipped with a spindle unit or a disk rotator is smaller, has lower energy consumption, and is lower cost than in the past.

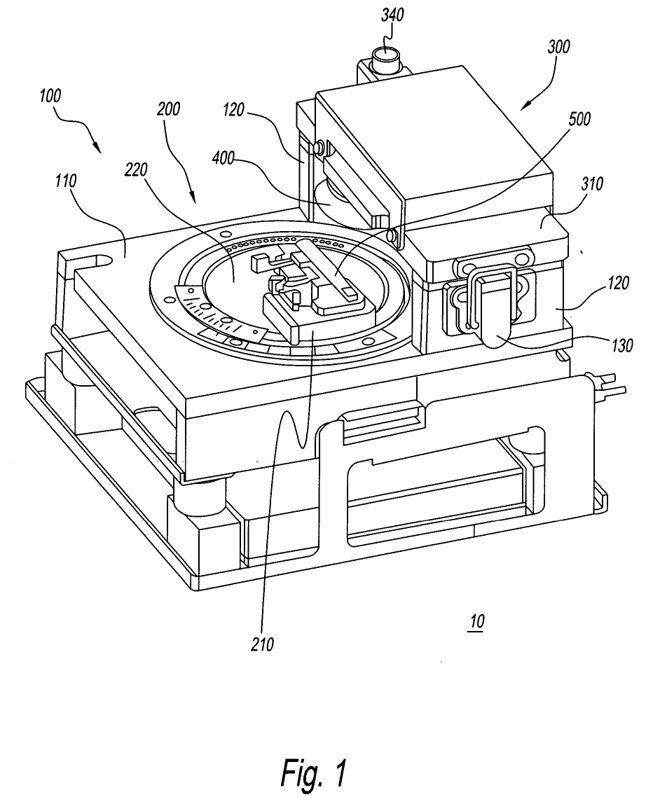

Next, the present invention is explained based on a preferred embodiment while appropriately referring to the attached drawings. An embodiment of the present invention is a spinstand for testing at least one of a head and a disk. Below, FIG. 1 is referenced. FIG. 1 is a perspective view of the entire spinstand 10 of this embodiment. In the spinstand in FIG. 1, the spinstand 10 of this embodiment comprises a base 100, a head positioning device 200 which is an example of a head positioning means, and a spindle unit 300.

The base 100 is a cast aluminum base and has a plane part 110 and a frame 120. The frame 120 fixes the spindle unit 300. The frame 120 provides a fastener 130 for fixing the spindle unit 300. Means for fixing the spindle unit 300 to the base 100 can be any means if the test operator can easily install and remove the spindle unit 300 from the base 100. For example, instead of the fastener 130, an air chuck or an electromagnet can be used.

The head positioning device 200 positions a head gimbal assembly (HGA) 500, an example of the head, at the specified position. The head positioning device 200 comprises a linear fine positioning device 210 and a rotation positioning device 220. The rotation positioning device 220 sets the rotation position of the linear fine positioning device 210. The linear fine positioning device 210 positions the HGA 500. The HGA 500 is installed to enable installing and removing from the linear fine positioning device 210.

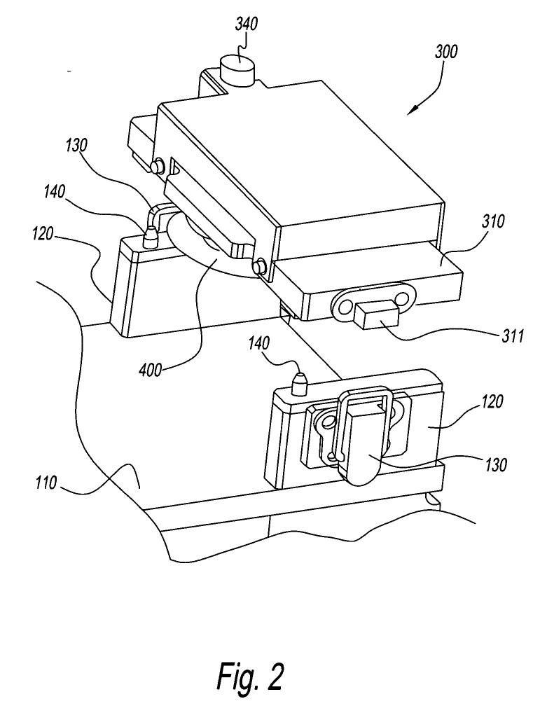

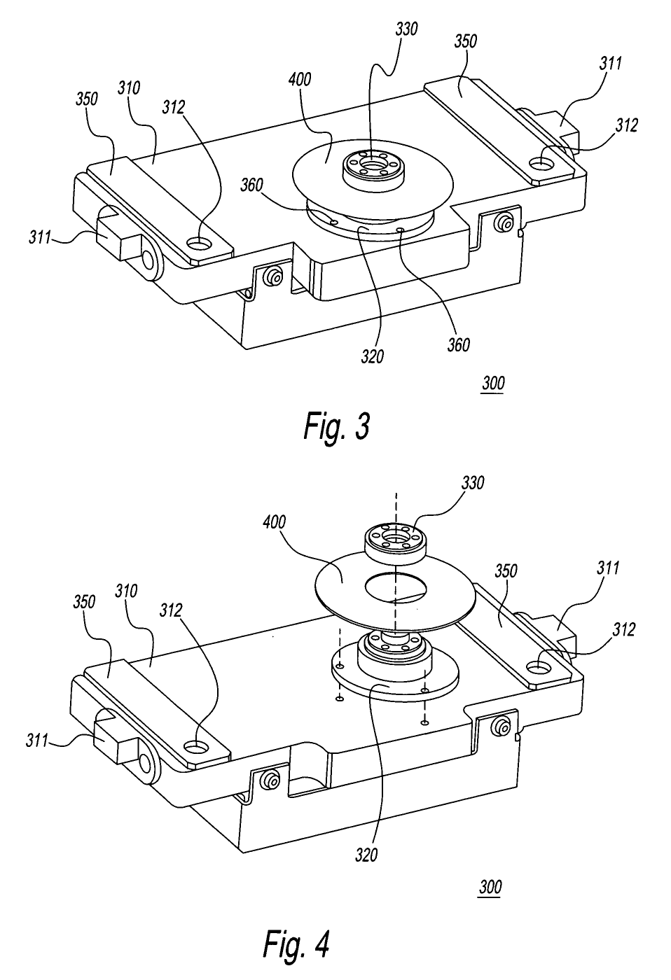

Now, FIGS. 2 to 4 will be referenced in addition to FIG. 1. FIG. 2 is a perspective view of the area surrounding the frame 120 in FIG. 1. FIG. 3 is a perspective view of the spindle unit 300 holding a disk 400. FIG. 4 is an exploded view of the disk 400 and the spindle unit 300.

The spindle unit 300 comprises an aluminum spindle base 310; a fluid dynamic bearing motor 320, which is an example of the disk drive; a hub 330, a connector 340, and a stainless protective plate 350. The spindle base 310 has a projection 311 for engaging the fastener 130 and is fixed to enable installing and removing from the frame 120 by using the fastener 130. The fastener 130 is indicated as a snap latch in the figure. However, if the fastener is means for easily fixing and releasing the spindle unit 300, other embodiments of the fastener such as a buckle are acceptable. Positioning pins 140 are protruding from the frame 120. The spindle base 310 has a hole 312 where positioning pin 140 can set in. The spindle base 310 is positioned on a plane perpendicular to the positioning pin 140 by the positioning pin 140. The positions of the pin 140 and the hole 312 can be optionally changed by mechanical processing. As a result, for example, the test operator can set the distances of the center of the rotation axis of the rotation positioning device 220 and the center of the rotation axis of the fluid dynamic bearing motor 320 to be equal to the distance in an actual hard disk drive or to any other optional values. The protective plate 350 protects from the wear caused by repeated installing and removing. Although not shown, a stainless protective plate is similarly installed in the part contacted by the spindle unit 300 in the frame 120. Furthermore, the disk 400 is loaded on the fluid dynamic bearing motor 320 and is fixed to the fluid dynamic bearing motor 320 by the hub 330. The hub 330 is fixed by screws to the fluid dynamic bearing motor 320 and can be easily installed and removed by the test operator. The means for fixing the disk 400 to the fluid dynamic bearing motor 320 can be any means that enables the test operator to easily install and remove the disk 400 from the fluid dynamic bearing motor 320. For example, instead of the hub 330, some clamping means can be used. The fluid dynamic bearing motor 320 is installed so as to enable installing in and removing from the spindle base 310. The fluid dynamic bearing motor 320 is fixed by screws to the spindle base 310. The means for fixing the fluid dynamic bearing motor 320 to the spindle base 310 can be any means that enables the test operator to easily install and remove the fluid dynamic bearing motor 320 from the spindle base 310. For example, instead of screws 360, the fastener described above can be used. The fluid dynamic bearing motor 320 can rotate the disk 400 at rotational speeds based on the inspection specification. Usually, the rotation speeds based on the inspection specification are typical rotational speeds of the disk loaded in a hard disk drive. The fluid dynamic bearing motor 320 can rotate the disk 400 at another single rotational speed. Furthermore, the fluid dynamic bearing motor 320 can rotate the disk 400 at various rotational speeds. As needed, the fluid dynamic bearing motor 320 can continuously or discretely vary the rotation speed within some range. The fluid dynamic bearing motor 320 can be more compact and lighter in weight while achieving the same rigidity as a hydrostatic air bearing motor used in the past. A method that limits the specification demanded for the disk rotator and provides a variety of spindle units for holding a disk rotator having different specifications readily enables the usage of a fluid dynamic bearing motors, and is beneficial in reducing the size and weight, lowering the power consumption, and lowering the cost of the spinstand.

The spinstand 10 of the present invention as constructed above is advantageous compared to a conventional spinstand when exchanging the disk.

For example, when a disk having the same specification is exchanged when a disk was damaged, first, a replacement spindle unit is provided separately from the spindle unit 300 already installed in the spinstand 10. At this time, a replacement disk having the same specification as the disk 400 held in the spindle unit 300 is preloaded in the replacement spindle unit. The fixed state of the fastener 130 is released, and the spindle unit 300 holding the damaged disk 400 is removed bodily from the spinstand 10. In the exchange, the replacement spindle unit that holds the replacement disk is fixed to the spinstand 10 by the fastener 130. The damaged disk 400 is removed from the spindle unit 300 outside of the installation location of the spinstand, and a new disk is loaded in the spindle unit 300. If a disk is exchanged as described above, the test operator can remove the disk 400 from the spinstand 10 and load the replacement disk in the spinstand 10 without touching the disk 400 or the replacement disk. Removing the spindle unit 300 and installing the replacement spindle unit are simple compared to handling the disk 400 or the replacement disk. Therefore, the time for disk exchange by the operator can be substantially decreased compared to the past. As a result, the down time of the spinstand 10 is also substantially reduced. Since the operator can exchange the disk without touching the disk, the occurrence of accidents accompanying the handling of disks can be suppressed. Furthermore, if the operator trained in disk exchange installs or removes the disk of the spindle unit, the reliability of the disk exchange operation can be improved. Furthermore, since installing and removing the disk of the spindle unit can be performed by the operator trained in disk exchange at a single central location, the inspection efficiency and the operating efficiency of the disk exchange can be improved compared to when an operator trained in disk exchange went to the installation location of the spinstand to perform the exchange as in the past. At least one replacement spindle unit that holds the replacement disk is provided for one spinstand or at least one replacement spindle unit is provided for all of the multiple spinstands installed at the inspection location. For example, when 10 spinstands are installed at the inspection location, at least one spindle unit is provided for exchange aside from the 10 spindle units installed in these spinstands. It is more desirable if at least one replacement spindle unit is provided for each spinstand. When 10 spinstands are installed at the inspection location, at least 10 replacement spindle units are provided aside from the 10 spindle units installed in the spinstands. In the above explanation each spindle unit holds a disk during the spindle unit exchange in the spinstand. When the measurements before and after disk exchange are based on the same specification, the fluid dynamic bearing motor provided in the replacement spindle unit is identical to the fluid dynamic bearing motor 320.

When the measurement specification changes, for example, when the disk exchange is conducted in order to perform measurement using a disk having a different diameter, the spinstand 10 of the present invention as described above is advantageous compared to a conventional spinstand. In this case, first, a replacement spindle unit is provided separately from the spindle unit 300 already installed in the spinstand 10. The replacement disk having a different specification than the disk 400 held by the spindle unit 300 is preloaded in the replacement spindle unit. The fixing state of the fastener 130 is released, and the spindle unit 300 holding the disk 400 is removed bodily from the spinstand 10. As the replacement, the replacement spindle unit that holds the replacement disk is fixed to the spinstand 10 by the fastener 130. The removed spindle unit 300 is stored, loaded with a disk different from disk 400 or installed in another spinstand different than spinstand 10. If a disk is exchanged as described above, the test operator can remove the disk 400 from the spinstand 10 and load a disk suited to a new inspection specification in the spinstand 10 without touching disk 400 or the replacement disk. Removing the spindle unit 300 and installing the replacement spindle unit are simple compared to handling disk 400 or the replacement disk. Therefore, the time for disk exchange by the operator is substantially shortened compared to the past. Consequently, the down time of the spinstand 10 is substantially shortened. Since the operator can exchange the disk without touching the disk, the occurrence of accidents accompanying the handling of disks can be suppressed. Furthermore, if the operator trained in disk exchange installs or removes the disk of the spindle unit, the reliability of the disk exchange operation can be improved. Furthermore, installing and removing the disk of the spindle unit can be performed by the operator trained in disk exchange centralized at a single location and can improve the inspection efficiency and the operating efficiency of the disk exchange compared to when the operator trained in disk exchange went to the installation location of the spinstand as in the past. At least two types of spindle units each holding one of at least two types of disks are provided for one spinstand. Alternately, the total number spindle units is at least the number of spinstands installed at the inspection location, and at least two types of spindle units each holding one of at least two types of disks are provided. For example, if 10 spinstands are installed at the inspection location and spindle units each holding different disk are installed in the spinstands, 10 types of spindle units the total number of which is at least 10 are provided. The number of types and the number of spindle units for each type to be provided can be selected without restriction. In addition, the spindle units provided in this manner have the option of how to assign them to the spinstands. In the above explanation, during spindle unit exchange in the spinstand, each spindle unit holds a disk.

The inspection specification relating to the disk rotator, such as the disk rotation speed and the direction of disk rotation, often differs with each inspection. A conventional spinstand fixed the air spindle motor to the base as the disk rotator to cover a wide range of inspection specifications. The spinstand of the present invention can exchange the disk rotator by exchanging the spindle unit. Thus, a head or a disk can be tested by preparing multiple spindle units having different disk rotators and combining the spindle unit selected in accordance to the inspection specification with the base of the spinstand. For example, in the following procedure, the motor, which is an example of the disk rotator, is exchanged. First, a replacement spindle unit is provided separately from the spindle unit 300 already installed on the spinstand 10. A replacement fluid dynamic bearing motor having a different specification than the fluid dynamic bearing motor 320 held in the spindle unit 300 is pre-installed in the replacement spindle unit. A disk is preloaded on the replacement fluid dynamic bearing motor. Furthermore, the preloaded disk may be a disk having the same specification as disk 400 or a disk having a different specification than disk 400. Then the fixed state of the fastener 130 is released, and the spindle unit 300 holding the disk 400 is removed unmodified from the spinstand 10. In the exchange, a replacement spindle unit holding the disk is fixed to the spinstand 10 by the fastener 130. The removed spindle unit 300 is stored, the fluid dynamic bearing motor 320 is replaced by a different motor or installed in another spinstand different from spinstand 10. If the motor is exchanged as described above, each spindle unit no longer needs to cover the entire wide range of specifications and can use an extremely small spindle motor using a fluid dynamic bearing. At least two types of spindle units are provided for holding one of the at least two types of disk rotators for one spinstand. Alternately, the number of spindle units is at least the number of multiple spinstands installed at the inspection location, and at least two types of spindle units are provided. For example, when 10 spinstands are installed at the inspection location, and a spindle unit holding a fluid dynamic bearing motor different from each other is installed in each spinstand, where the total number of spindle units is at least 10 and 10 types of spindle units are provided. In the above explanation, each spindle unit holds a disk during the spindle unit exchange in the spinstand.

As explained above, the spindle unit of the present invention is featured by holding a disk rotator and a disk. If at least two spindle units that appropriately combine disk rotators or disks are provided for the spinstand, the disk exchange operation is improved, and the degrees of freedom in selecting the disk rotator is improved.

As explained above, instead of exchanging the spindle unit, the disk rotator may be exchanged. In this case, the spinstand has a structure that enables the test operator to easily access the disk rotator. For example, the spinstand has a structure where the seating surface of the disk rotator is raised slightly so that the test operator grasps the disk rotator without touching the disk. The seating surface of the disk rotator is the face opposite the face where the disk is loaded. The exchange or preparation of the disk rotator conforms with the exchange or preparation of the spindle unit described above. As a precaution, the following important points are explained.

First, when exchanging disks having the same specification such as a case when a disk was damaged, the motor fixed to a spinstand and the replacement motor can be exchanged in the state where the respective disks are held. At least one replacement motor holding the replacement disk is provided for one spinstand, or at least one replacement motor holding the replacement disk is provided for the entire spinstands installed at the inspection location.

When a disk exchange is performed in order to do inspection using disks having different diameters, the motor fixed to the spinstand and the replacement motor can be exchanged in the state where the respective disks are held. In this case, the respective specifications of the disks held by the motors differ. At least two motors can be motors having different specifications or motors having the same specification. At least two motors for holding one of the at least two types of disks are provided for one spinstand. Alternately, the total number of motors is at least the number of spinstands installed at the inspection location, and at least two motors are provided.

Furthermore, when the disk rotational speed changes, the motor fixed to the spinstand and the replacement motor can be exchanged in a state where the respective disks are held. In this case, the disks held by the motor can be disks having different specifications or disks having the same specification. At least two motors are provided for one spinstand. Alternately, the total number of motors is at least the number of spinstands installed at the inspection location, and at least two motors are provided.

In the above description, the number of types and the total number of prepared spindle units can be freely selected. The spindle unit or the disk rotator freely provided has the option of the system construction on how to assign to the spinstands. Similarly, the number of types and total number of disk rotators to be provided for each spinstand can be freely selected. The freely provided disk rotator has the option of the system construction on how to assign to the spinstands.

The present invention can be applied to a spinstand providing at least two spindle units or disk rotators fixed so as to enable installation or removal as well as a spinstand providing a spindle unit or a disk rotator that can be installed and removed as described above.

1. A spindle unit for exchanging a disk or a disk rotator for holding and rotating the disk in a spinstand for testing at least one component selected from the group consisting of: a head and a disk, said spindle unit comprises:
a disk rotator, and
a spindle base equipped with the disk rotator, wherein
the spindle base is fixed to the spinstand so as to enable installation and removal by the operator of the spinstand.

2. The spindle unit according to claim 1, wherein said disk rotator has a mechanism for holding the disk detachably, and said disk is exchanged in the disk rotator outside of the spinstand.

3. The spindle unit according to claim 1, wherein said disk rotator is fixed detachably in the spindle base, and said disk rotator is exchanged in the spindle base outside of the spinstand.

4. The spindle unit according to any one of claim 1, wherein said disk rotator is selected in accordance with the inspection specification from a variety of disk rotators.

5. The spindle unit according to claim 4, wherein said disk rotator comprises a fluid dynamic bearing motor.

6. The spindle unit according to claim 1, wherein said spindle unit has a controller for rotating the disk.

7. The spindle unit according to claim 1, further comprising at least one connector which electrically connects to the spinstand.

8. A spinstand which comprises:
a spindle unit for exchanging a disk or a disk rotator for holding and rotating the disk in a spinstand for testing at least one of a head or a disk, said spindle unit comprises: a disk rotator, and a spindle base equipped with the disk rotator, wherein the spindle base is fixed to the spinstand so as to enable installation and removal by the operator of the spinstand;
a base for fixing the spindle unit; and
a head positioner for holding the head and positioning the head relative to a disk held by the spindle unit.

9. A spinstand system comprised of a spinstand for testing at least one component selected from the group consisting of: a head and a disk, and a set of disk rotators that can be installed in and removed from the spinstand, wherein
said spinstand has a structure where at least one of a set of the same type of disk rotators is fixed and the disk rotator is exchanged while the disk is held in the disk rotator.

10. The spinstand system according to claim 9, wherein a set of the same type of disk rotators is selected in accordance with the inspection specification from a plurality of types of disk rotators.

11. A spinstand system which comprises a spinstand for testing at least one component selected from the group consisting of: a head and a disk, and a set of disk rotators which is able to be installed in and removed from the spinstand, wherein the spinstand fixes detachably the disk rotator selected corresponding to the inspection specification from multiple types of disk rotator and the disk rotator can be exchanged while the disk is held by the disk rotator.

12. A method of disk exchanging in a spinstand with a first disk rotator fixed detachably, wherein said method of disk exchanging comprises:
providing a second disk rotator separate from the first disk rotator fixed to the spinstand and loaded with a first disk;
preloading a second disk in the second disk rotator before installing in the spinstand;
removing the first disk rotator from the spinstand while the first disk is loaded; and
fixing the second disk rotator loaded with the second disk to the spinstand.

13. A method of disk exchanging in a spinstand where a first spindle unit having the disk rotator is fixed detachably, wherein said method of disk exchanging comprises:
providing a second spindle unit separate from said first spindle unit fixed to the spinstand and loaded with the first disk;
preloading a second disk in the second spindle unit before installing in the spinstand;
removing the first spindle unit from the spinstand while the first disk is loaded; and
fixing the second spindle unit loaded with the second disk to the spinstand.
